(19) United States
(12) Patent Application Publication
(10) Pub. No.: US 2014/0095213 A1
(43) Pub. Date: Apr. 3, 2014

(54) SYSTEM AND METHOD FOR COORDINATING TRANSACTIONS

(71) Applicants: Shaun Michael Gwilliam, Gloucestshire (GB); Terje Gloerstad, Scottsdale, AZ (US); David R. McEldowney, Gold Canyon, AZ (US); Robert M. Wilkison, Scottsdale, AZ (US)

(72) Inventors: Shaun Michael Gwilliam, Gloucestshire (GB); Terje Gloerstad, Scottsdale, AZ (US); David R. McEldowney, Gold Canyon, AZ (US); Robert M. Wilkison, Scottsdale, AZ (US)

(21) Appl. No.: 13/841,203

(22) Filed: Mar. 15, 2013

Related U.S. Application Data
(60) Provisional application No. 61/744,755, filed on Oct. 3, 2012.

(51) Int. Cl. G06Q 40/08

(52) U.S. Cl. CPC G06Q 40/08
USPC 705/4

(57) ABSTRACT

An integration system comprises a transaction hub electronically communicating with a compatibility server. The transaction hub receives initial data including a transaction code. The transaction hub transmits vehicle identification data to the compatibility server based on the transaction code. The compatibility server identifies a vehicle based on the vehicle identification data, identifies any potential devices compatible with the vehicle, and identifies one of the potential devices based, at least in part, on prior feedback of at least one compatibility parameter. The compatibility server transmits device identifying data to the transaction hub.

This application claims priority to, and the benefits of, U.S. Provisional Application No. 61/744,755 filed on Oct. 3, 2012, which is incorporated by reference herein in full.

### BACKGROUND

The present invention relates to systems and methods of providing insurance products. In particular, the invention relates to managing workflow and coordinating communications for a usage-based insurance platform as a service.

Providing usage-based insurance, other insurance products, and/or fleet management for various external carriers requires coordinating communications between the different external carriers and internal modules. Data received from the different external sources (e.g., from different carriers) must be transformed and then transmitted between different internal modules and external parties to perform various activities such as registering a new user, identifying compatible equipment, shipping equipment to the user, etc. Coordinating such activities requires efficient communications between the various parties.

The present invention provides a new and improved apparatus and method for coordinating transactions and communications in a usage-based insurance environment.

The following patent applications are incorporated by reference herein in full: U.S. Provisional Application No. 61/749,600, filed Jan. 7, 2013; U.S. application Ser. No. 13/837,955, filed Mar. 15, 2013; U.S. Provisional Application No. 61/762,547, filed Feb. 8, 2013, along with a counterpart U.S. non-provisional application titled SYSTEMS AND METHODS FOR PROVIDING A DRIVING PERFORMANCE PLATFORM (Attorney Docket No. 35096.04011), filed Mar. 15, 2013; U.S. application Ser. No. 13/835,381, filed Mar. 15, 2013; and U.S. application Ser. No. 13/839,681, filed Mar. 15, 2013.

### SUMMARY

In one embodiment, it is contemplated that an integration system comprises a transaction hub electronically communicating with a compatibility server. The transaction hub receives initial data including a transaction code. The transaction hub transmits vehicle identification data to the compatibility server based on the transaction code. The compatibility server identifies a vehicle based on the vehicle identification data, identifies any potential devices compatible with the vehicle, and identifies one of the potential devices based, at least in part, on prior feedback of at least one compatibility parameter. The compatibility server transmits device identifying data to the transaction hub.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a block diagram showing an exemplary insurance platform in accordance with one embodiment of an apparatus illustrating principles of the present invention;

FIG. 2 illustrates a schematic representation of a block diagram showing an exemplary integrated insurance platform including native insurance-based systems in accordance with one embodiment of an apparatus illustrating principles of the present invention;

FIG. 3 illustrates a schematic representation of a block diagram showing an exemplary integrated insurance platform including providing an exemplary usage-based insurance platform as a service in accordance with one embodiment of an apparatus illustrating principles of the present invention;

FIG. 4 illustrates a schematic representation of a block diagram showing an exemplary integration system and an exemplary process for enrolling a new customer in accordance with one embodiment of an apparatus illustrating principles of the present invention;

FIG. 5 illustrates a schematic representation of a block diagram showing an exemplary driver profile module in accordance with one embodiment of an apparatus illustrating principles of the present invention;

FIG. 6 illustrates a schematic representation of a block diagram showing the exemplary integration system and an exemplary process for changing a device configuration in accordance with one embodiment of an apparatus illustrating principles of the present invention;

FIG. 7 illustrates a schematic representation of a block diagram showing the exemplary integration system and another exemplary process for changing a device in accordance with one embodiment of an apparatus illustrating principles of the present invention;

FIG. 8 illustrates an exemplary depiction of exemplary communication protocols and exemplary devices containing an application of the insurance platform.

### DETAILED DESCRIPTION OF ILLUSTRATED EMBODIMENT

The following includes definitions of exemplary terms used throughout the disclosure. Both singular and plural forms of all terms fall within each meaning:

“Address”, as used herein, includes but is not limited to one or more e-mail addresses, a distribution list including one or more e-mail addresses, uniform resource locator (URL) and file transfer protocol (FTP) locations or the like, network drive locations, a postal address, a combination of an e-mail address and a postal address, or other types of addresses that can identify a desired destination.

“Computer Readable Medium”, as used herein, includes but is not limited to any memory device, storage device, compact disc, floppy disk, or any other medium capable of storing data temporarily and/or permanently that can be interpreted by a computer.

“Device”, as used herein, includes any machine or component that attaches to and/or communicates with a computing device. Examples of peripheral devices, which are separate from a main computing device, include disk drives, printers, mice, and modems. Examples of integrated peripherals, which are incorporated into a main computing device, include central processing units and application specific integrated circuits. Most devices, whether peripheral or not, require a program called a device driver that acts as a translator, converting general commands from an application into specific commands that the device understands. The telematics device 104, which is discussed below, is an exemplary device.

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other logic device. Logic may also be fully embodied as software.

“Network”, as used herein, includes but is not limited to the Internet, intranets, Wide Area Networks (WANs), Local Area Networks (LANs), and transducer links such as those using Modulator-Demodulators (modems).

“Platform”, as used herein, includes but is not limited to a computing system that combines hardware and software, including application frameworks. The platform may include a computer architecture, operating system, programming languages, and related user interfaces, including run-time system libraries and/or graphical user interfaces.

“Signal”, as used herein, includes but is not limited to one or more electrical signals, analog or digital signals, one or more instructions, a bit or bit stream, or the like. The term “command” is synonymous with “signal.”

“Software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system (OS) or other type of executable instructions. It will be appreciated by one of ordinary skill in the art that the form of software is dependent on, for example, requirements of a desired application, the environment it runs on, and/or the desires of a designer/programmer or the like.

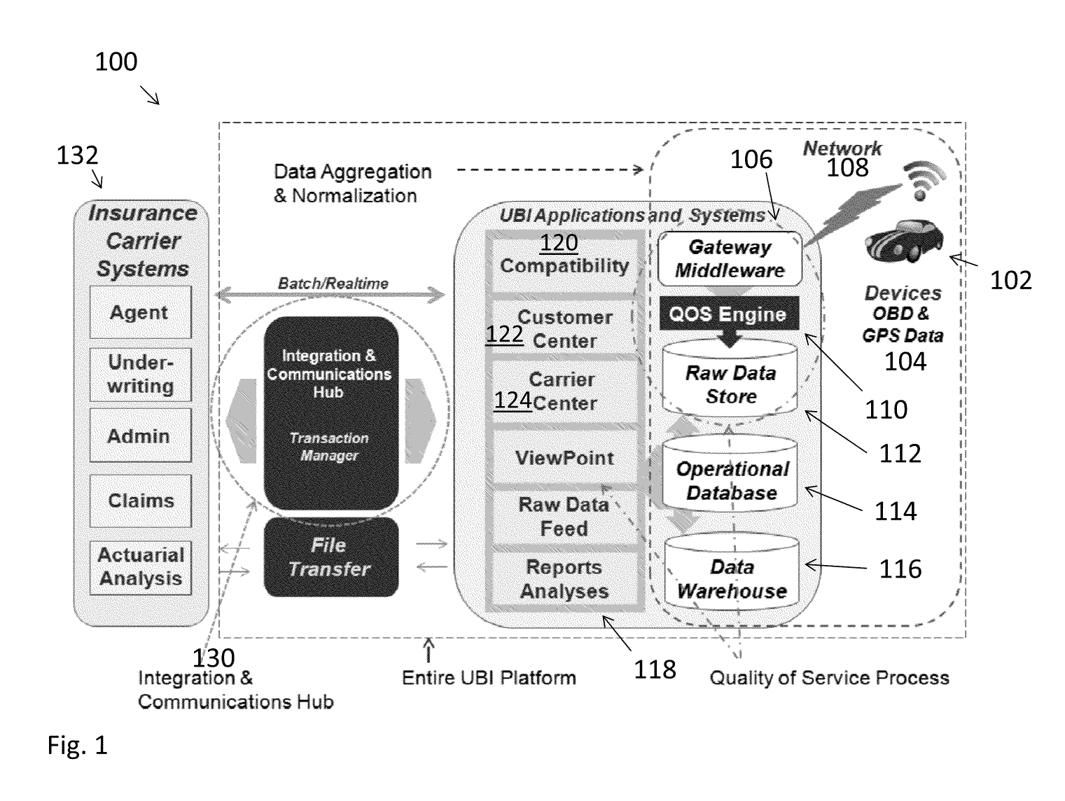

With reference to FIG. 1, a simplified component diagram of a block diagram showing an exemplary insurance platform is illustrated in accordance with one embodiment of the present invention. FIG. 1 shows an exemplary insurance support/enhancement platform 100, including exemplary hardware and software elements supporting carriers providing insurance, including, for example, usage-based insurance (UBI). As used herein, UBI includes usage-based insurance, behavior-based insurance (BBI), and other incentive or discount based insurance programs that may include use and behavior based elements including, for example, mileage, trips, driving performance and habits, geospatial data, etc. In other embodiments, the platform 100 may also be applicable to commercial/fleet management and self insurers, as discussed in more detail below.

In this exemplary platform 100, data, such as, for example, latitude/longitude of a vehicle 102 is captured and/or transmitted, for example, over-the-air (e.g., wirelessly) from a device 104, associated with the vehicle 102, such as a dongle device, on-board diagnostic (OBD) device, global positioning system (GPS) device, iOS or Android device, or other telematics device to a gateway 106 via, for example, network 108. In some embodiments, data may be captured and/or transmitted directly from the vehicle 102, such that the vehicle 102 or a component of the vehicle 102 is the device 104. The device 104 may or may not be connected to the vehicle 102. Data aggregation and normalization can occur using, for example, systems and methods described in U.S. Provisional Patent Application No. 61/744,755, filed Oct. 3, 2012, and U.S. application Ser. No. 13/835,381, filed Mar. 15, 2013, which as noted above are incorporated herein by reference in full.

Data may be processed through a Quality of Service (QOS) engine 110, which can evaluate data packets and aggregated packets (trips) and can pass results through algorithms for data retention and use. Resulting raw data can be stored in raw data store 112 and passed to an operational database 114 and data warehouse 116, which may allow some applications 118 (e.g., a compatibility server 120, Customer Center 122, a Carrier Policy Management Center 124 (e.g., a carrier center or a carrier module), ViewPoint, etc.) to access the data directly and other applications (e.g., Actuarial Process) to access the data via, for example, File Transfer Protocol (FTP). An integration and communications hub 130 can manage transactions to and from exemplary insurance carrier systems 132. These communications and transactions may include, for example, logistics for ordering the device 104, dashboards for viewing driving results as recorded by the device 104, processes for managing insurance rates, etc.

Together, many of these components may be a part of a structure for an integrated UBI platform. Integrating various components of the insurance platform 100 with external and/or private systems can result in a UBI platform that may be offered as a service, for example, to insurance carriers that want to quickly engage in UBI without developing the capability organically or internally. Essentially, providing a “turn-key” UBI platform that can integrate with existing systems, transforming them into a system capable of offering UBI to customers. For example, offering a UBI platform as a service (PaaS) may allow an insurance carrier to expedite launch of an enterprise UBI initiative and facilitate ongoing UBI program management. This UBI platform can harness the power of cloud computing and insurance technology expertise to deliver production-ready, compliant UBI administration. The platform's system architecture can be device 104 and network 108 agnostic, highly scalable, modular, transparent, supportive of hosting and business process outsourcing, etc. The platform can cover, for example, device 104 management, data management, QOS processes, transaction management, and data feeds to user applications. The PaaS may be offered to platform customers, such as, for example, insurance carriers or providers, by a platform administrator or integrator. For example, the UBI in a Box™ platform is a PaaS offered by The Evogi Group. Some embodiments of the PaaS may also be applicable to commercial/fleet management and self insurers, as discussed in more detail below.

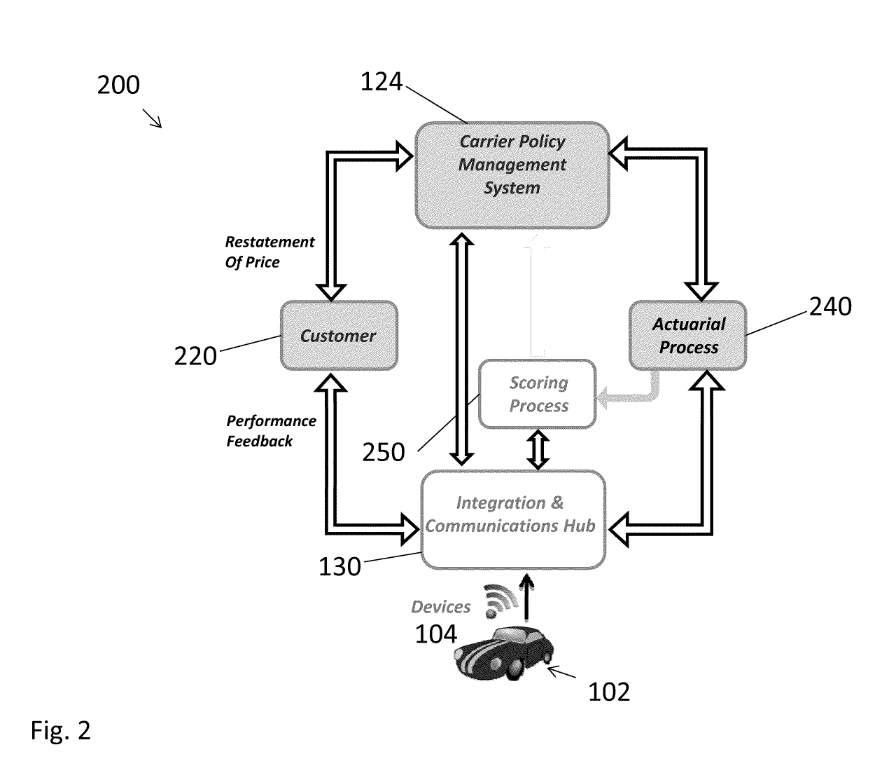

With reference to FIG. 2, an exemplary insurance platform 200 integrates various components of the exemplary insurance platform 100 with native insurance-based systems. The combined insurance platform 200 may include various hardware and software components capable of implementing the functions described below. All of these components may be integrated into one or more platforms in such a manner that allows the insurance platform 200 to seamlessly provide UBI as a service. For example, in this embodiment, the insurance platform 200 shows an exemplary vehicle 102 including an exemplary device 104 communicating data to the exemplary integration and communications hub 130. In some embodiments, the integration and communications hub 130 may include or be a part of all or portions of the UBI applications and systems from insurance platform 100 and may also include all or portions of the integration and communications hub 130 from insurance platform 100, as shown in FIG. 1.

The insurance platform 200 may also include applications that can interface with, for example, users and other systems. These may include, for example, a customer 220, the carrier policy management system 124, and an actuarial process 240. The customer 220, the carrier policy management system 124, and the actuarial process 240 may be specific to a UBI offering or may be common to both UBI and other insurance-based products or systems. Exemplary customers 220 include policy holders of carriers. An exemplary function of the carrier database 124 is a restatement of price or rate quote issuance (RQI), including, when the carrier calculates and sends a quote for a new rate at renewal or mid-term if there is a policy change. In some embodiments, the carrier policy management system 124 and the actuarial process 240 may be included in one system, such as, for example, an integrated insurance carrier system or platform. The insurance platform 200 may also include a scoring process 250, as discussed in U.S. Provisional Appln. No. 61/762,547, filed Feb. 8, 2013, along with a U.S. non-provisional application titled SYSTEMS AND METHODS FOR PROVIDING A DRIVING PERFORMANCE PLATFORM (Attorney Docket No. 35096.04011), filed Mar. 15, 2013, which as noted above are incorporated herein by reference in full. In some embodiments, the scoring process 250 may include or be a part of all or portions of the UBI applications and systems from insurance platform 100 and may also be associated with all or portions of the integration and communications hub 130 from insurance platform 100, as shown in FIG. 1. Therefore, the insurance platform 200 may act as a data collector and provide the data to the carrier, which may use a carrier based algorithm to calculate scores. As an alternative, the insurance platform 200 may include an algorithm or integrate a carrier provided algorithm to calculate a score. The carrier would then send the insurance platform 200 a transaction through the integration hub to request a score, which the insurance platform 200 in turn would return to the carrier. An extension of this process would be that the carrier calculates the score and then sends the insurance platform 200 some messaging to be displayed to the customer. For example, the messaging may indicate that based on the customer's driving performance, the customer is tracking towards a 15% discount at the next policy renewal. Alternatively, the insurance platform 200 could calculate the score and then, based on carrier defined business rules, match the score against a look-up table and generate similar customer messaging.

As shown in FIG. 2, the various components of the insurance platform 200 can communicate with each other to exchange data and information, in addition to the communication arrows shown in FIG. 2. Also shown in FIG. 2, the components can also cooperate with each other to provide user services, such as, for example, performance feedback and restatements of policy prices.

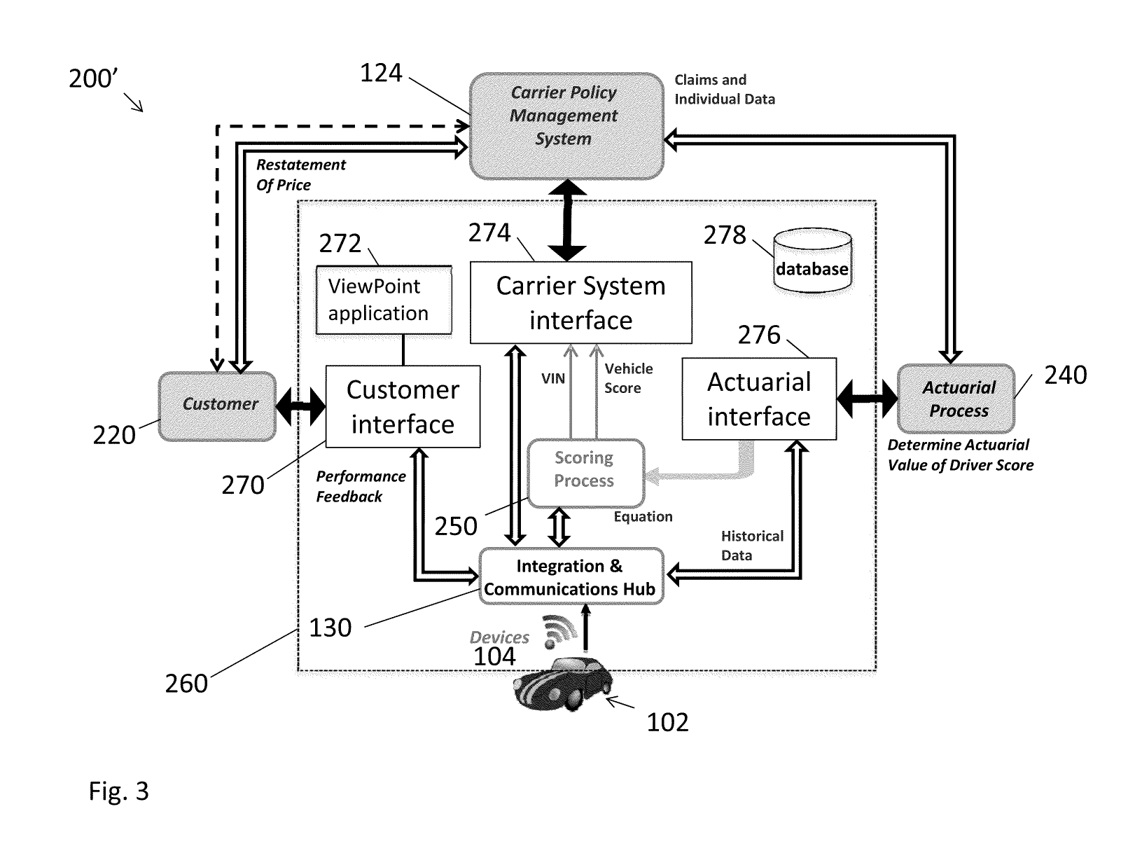

FIG. 3 depicts another embodiment of an exemplary insurance platform 200′ that also incorporates various components of the exemplary insurance platform 100. Exemplary insurance platform 200′ includes an exemplary UBI PaaS, shown as UBI platform 260. The UBI platform 260 represents exemplary components and/or systems of a UBI PaaS, which can be used to facilitate providing UBI to customers 220. The insurance platform 200′ may include various hardware and software components similar to those of the insurance platform 200 from FIG. 2, but the UBI platform 260 includes various interfaces capable of interfacing with systems and/or users external to the UBI platform. For example, in this embodiment, the UBI platform 260 includes, for example a customer interface 270, an application for QoS and Web analytics (e.g., ViewPoint application 272), a carrier system interface 274, and an actuarial interface 276. Other embodiments may include various combinations of these interfaces or additional interfaces.

These interfaces allow the UBI platform 260 to integrate and/or interface with native entities, such as, for example, vehicles 102 via devices 104 and the integration and communications hub 130, customers 220 via the customer interface 270, an existing carrier policy management system 124 via the carrier system interface 274, and an existing actuarial process 240 via the actuarial interface 276. In this manner, the UBI platform 260 provides a “turn-key” UBI platform that can integrate with existing systems, transforming them into a system capable of offering UBI to customers. These interfaces may include, for example, user interfaces, individual application programming interfaces (APIs), a framework of APIs, function calls, or any other logic to facilitate interfacing with systems or users external to the UBI platform 260. The UBI platform 260 may also include database 278, which may include or be a part of all or portions of the databases included in the UBI applications and systems from insurance platform 100, as shown in FIG. 1. The database 278 may be utilized by any of the components and/or systems of the insurance platform 200′, including the UBI platform 260, to store data.

In another embodiment, carriers may choose to utilize the UBI platform 260 for various communications other than those associated with UBI, including utilizing the UBI platform 260 as a single point of communication for the customer 220 regarding all of their activities with the carrier, via the customer interface 270. For example, the restatement of price may be communicated to the customer 220 via the UBI platform 260 and the customer interface 270. However, in this embodiment, communications can still occur between the customer 220 and the carrier outside of the UBI platform 260, including, for example, for items not associated with UBI. FIG. 3 shows a dotted line between the customer 220 and the carrier policy management system 124 for these types of communications (i.e., for example, when the restatement of price occurs through the UBI platform 260).

These interfaces allow for communication and data transfer between all of the components and systems of the insurance platform 200′, including through the UBI platform 260. In one embodiment, the customer interface 270 may be, for example, a user interface for login of customers 220. Customers 220 may be able to access information associated with their UBI from the UBI platform 260. In other embodiments, the login may be a “single login” that can facilitate access to information associated with their UBI and any other insurance products or accounts associated with the customer 220, which may include non-UBI products. In other embodiments, the carrier system interface 274 may facilitate specific interactions. For example, the carrier policy management system 124 may communicate with the compatibility server 120 (see FIG. 1) of the UBI platform 260 before a UBI quote is started, to determine whether a compatible device 104 is available for the potential customer's vehicle 102. In another example, the carrier policy management system 124 may communicate with the integration and communications hub 130 of the UBI platform 260 when the driver enrolls a vehicle 102 and the integration and communications hub 130 manages the enrollment process through the steps of sending the order to a third party and sending confirmation to the carrier policy management system 124. In other embodiments, the actuarial interface 276 may, for example, utilize FTP, export data into csv (comma separated values) files, store them on S3 (Amazon's cloud storage), and allow carriers to download them. In another example, the communications hub 130 may manage a billing and payment process for the cost of devices shipped to policyholders or fleet drivers.

In other embodiments, a commercial auto UBI platform may include all of the elements of the exemplary personal auto UBI platform 260 and additionally may offer, for example, a driver behavior management application, a customer fleet management portal, and/or data management for risk classification and risk management. The data structure may include account management, shipping and billing information at the driver and account level. The commercial auto UBI platform may also be provided by a platform integrator. For example, one embodiment for commercial auto, which may be configured for 1-4 vehicles, is provided by The Evogi Group. Another embodiment, which may be configured for fleets of 5-99 vehicles, is also provided by The Evogi Group. Features of an exemplary commercial auto UBI platform may include “At a Glance Vehicle Scores” and risky event monitoring, basic vehicle trend analysis with comparisons to other demographic groups, detailed trip and event metrics with daily and weekly summaries, single vehicle at a time mapping of vehicle routes and risk events, easy user management (e.g., the ability to give drivers access to individual vehicle views), internet browser compatibility (e.g., Chrome, IE, Firefox, OSX), mobile browser support, and user configurable basic alerts and driver score distribution. In another example, features of another exemplary commercial auto UBI platform may include real-time vehicle positioning, accident alerts (e.g., crash notification), support for device 104 with a buzzer, distracted driver integration (e.g., cell phone blocking applications triggered by GPS or OBD motion detection), vehicle 102 diagnostics (e.g., engine, seatbelts, airbag, etc.), and geospatial overlay (e.g., speed over posted speed limits, weather, road type, etc.).

As illustrated in this application, blocks or steps of flowcharts represent logic functions, actions and/or events performed therein. It will be appreciated by one of ordinary skill in the art that electronic and software systems involve dynamic and flexible processes such that the illustrated blocks and described sequences can be performed equivalently in different sequences or in parallel. It will also be appreciated by one of ordinary skill in the art that elements embodied as software may be implemented using various programming approaches such as, for example, machine language, procedural, object-oriented, or artificial intelligence techniques. It will further be appreciated by one of ordinary skill in the art that, if desired and appropriate, some or all of the software can be embodied as part of a device's operating system.

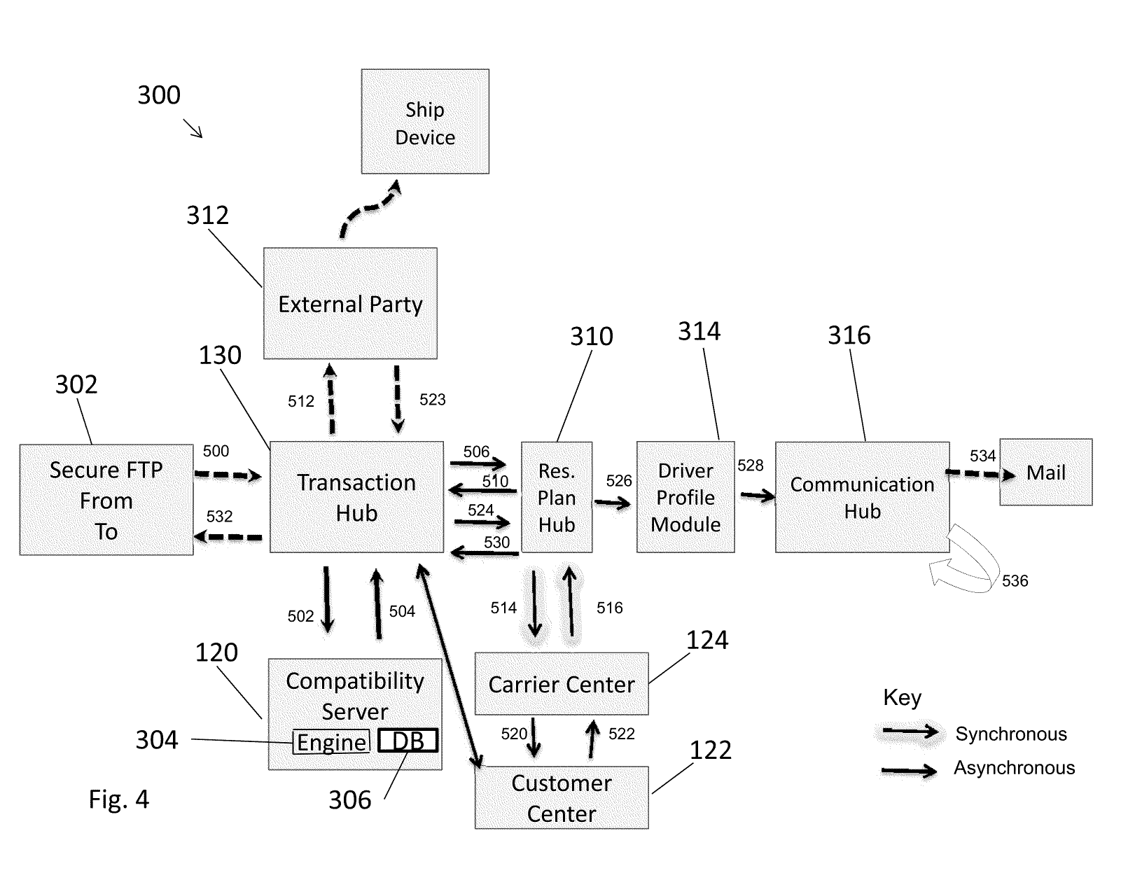

With reference FIG. 4, a block diagram showing of an exemplary integration system 300 for enrolling a new customer is illustrated in accordance with one embodiment of an apparatus illustrating principles of the present invention. In one embodiment, solid lines represent asynchronous communications between different components within the integration system 300, highlighted solid lines represent synchronous communications between the different components within the integration system 300, and dashed lines represent communications between the integration system 300 and external parties.

FIG. 4 is also an exemplary methodology of the process for enrolling a new customer. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIG. 4, a new customer enrollment is processed by receiving an incoming file from a carrier, step 500. The file is transmitted via, for example, secure FTP 302 to the integration hub 130 (transaction hub) in the step 500. The file may also be transmitted by a real-time REST interface. The data transmitted to the transaction hub 130 in the step 500 includes initial data such as, for example, the name and address of the new enrollee, identifying information of the vehicle 102 (see FIG. 1), and a transaction code. The transaction code may include identifiers such as NEW for a enrolling a new enrollee, INF (Information) for changing an enrollee's information, WIRx (Withdraw) for removing a vehicle or enrollee from the program, etc.

In a step 502, if the transaction code is NEW, the transaction hub 130 transmits data including identifying information of the vehicle 102 (see FIG. 1) to the compatibility server 120. In the illustrated embodiment, the compatibility server 120 electronically communicates with the transaction hub 130. In one embodiment, the data transmitted to the compatibility server 120 includes at least a partial vehicle identification number (VIN) (e.g., a “Squished” VIN or “VIN Pattern” of ten digits), which is used by the compatibility server 120 to identify a make, model, engine type, and year of the vehicle 102.

The compatibility server 120 includes a rules engine 304 for matching devices to vehicles. In one embodiment, the rules engine 304 of the compatibility server 120 matches devices to vehicles based on probabilities calculated from analysis of success rates by VIN. For example, parameters (e.g., factors) to be considered include engine size, ergonomics (e.g., position and/or location of the device under the vehicle dashboard), price of the device, operating cost of the device, likelihood of compatibility, etc. Specifically, there may be variations in the formats of a device's connection pin-outs and OBD protocols.

The compatibility server 120 may also include a compatibility database 306 with various types of compatibility data (e.g., at least one compatibility parameter) loaded. For example, the compatibility data may include manufacturer data about various devices and compatibility of those devices with various vehicles based on on-board diagnostic (OBD) pin port layout, engine size, diesel/electric engine, etc. In many cases, manufacturers may label several devices compatible for the same vehicle. As part of device management, rules may determine the best match for a particular vehicle having a particular make, model, and year (e.g., the vehicle 102 depicted in FIG. 1) and can continuously update this “best device” designation for the particular make, model, and year of the vehicle based on other data (including, for example, testing, customer feedback, and returns).

The compatibility server 120 may be accessed during the carrier's quote process. If there is not a compatible device for the specific vehicle being quoted, the quote process may stop. If the device issues for a particular vehicle are related to ergonomics (e.g., design), a carrier may establish a rule to allow or disallow a particular device for that vehicle. An alternate approach to accessing the compatibility server during the quote process is to provide access to a web-based compatibility checker. For example, a general agent or self-insurer could check device compatibility outside of a carrier's quoting process. An agent portal may be provided to support “pre-enrollment” activities. For example, an agent may look up compatibility by a vehicle make, model, year, and/or engine type or by a VIN (or at least a partial VIN). It is contemplated that the portal may query the database directly.

In addition, the compatibility data (e.g., at least one compatibility parameter) may also include historical data (e.g., parameters) collected by the platform integrator's testing, including, for example, bad data port locations that produce frequent signal disruption. The compatibility data may also include historical customer feedback or complaints about ergonomic issues (e.g., parameters) such as installation difficulty, dislodged devices due to port or device issues, etc. The compatibility data may also include data associated with devices returned for installation or performance failures.

The device integrator may also manage functionality capability issues. For example, competing device manufacturers such as, for example, OBD II manufacturers, may continually “leapfrog” one another to achieve market leadership. By partnering with these manufacturers, the device integrator can introduce continuous improvements and capabilities at rates that exceed competitors in the industry. In addition, working with multiple manufacturers may ensure that availability of particular devices never hinders an insurance carrier's need to meet demands arising from increased levels of customer or policy holder adoption.

Device management may also include proactively managing firmware requirements, device updates, and technical fixes to provide increased reliability, increased device longevity, support for multiple telematics programs, and better customer experiences. The device manager can also take advantage of the typically declining cost of devices when they occur. In this manner, the device manager can drive program costs down over time for insurance carriers. Based on all of the historical and current parameters discussed above, the compatibility server 120 identifies one of the devices 104 (see FIG. 1) out of a one or more potential devices.

Based on the above description, the compatibility server 120 identifies the vehicle 102 based on the data including identifying information transmitted in the Step 502. The compatibility server 120 then identifies any potential devices compatible with the vehicle 102. The compatibility server 120 then identifies one of the potential devices (e.g., the “best” device) as the device 104 to be used with the vehicle 102. As discussed above, the device 104 is chosen based on the customer feedback, failure rates, price, operating cost etc., and, therefore, is selected, at least in part, on prior feedback of at least one compatibility parameter. The compatibility server 120 transmits the data identifying the device 104 to the transaction hub 130 in a step 504.

If the transaction code is NEW, in a step 506, the data identifying the vehicle 102 and the device 104 identified by the compatibility server 120 are transmitted to a resource planning hub 310, which electronically communicates with the transaction hub 130. In a step 510, an order request is transmitted from the resource planning hub 310 to the transaction hub 130. In a step 512, data is transmitted from the transaction hub 130 to an external party 312 for shipping the device 104 to a driver, installer, and/or fleet manager. In a step 514, the resource planning hub 310 also transmits carrier data (identifying the carrier such as the carrier name, communication customizations, etc.) and data identifying the device 104 to the carrier module 124. The carrier data identifies configuration parameters e.g., which may be specifically related to a program for a target market, such as teen drivers, senior drivers, or commercial drivers, or may be related to the device profile (GPS vs. non-GPS) or type of data plan associated with the carrier for the device 104. The configuration parameters drive different reporting profiles, data collection and analysis schemes and user interfaces designed to meet state insurance regulatory requirements. The configuration parameters may also include a future effective date or data specifically required by the carrier that is not used by the integration system 300. The carrier center 124 transmits the configuration parameters to the resource planning hub 310 in a step 516. In one embodiment, the resource planning hub 310 transmits the order request to the transaction hub 130 in the step 510.

The carrier center 124 also transmits data to the customer center 122 in a step 520 so that the customer center 122 sets-up an account for the customer 220 (see FIG. 2). Once the customer is set-up the customer center 122, confirmation data is transmitted back to the carrier center 124 in a step 522. Alternatively, the customer center 122 may transmit the confirmation data directly back to the transaction hub 130.

Order status is returned from the external party 312 in a Step 523. For example, the external party 312 may confirm the device 104 has been shipped.

If the transaction code is NEW, in a step 524, the transaction hub 130 transmits transaction data to the resource planning hub 310 indicating the external party 312 confirmed the device 104 was shipped. After receiving the shipment confirmation from the transaction hub 130, the resource planning hub 310 transmits communication request data (e.g., profile request data), based on the transaction data, to a driver profile module 314 in a Step 526. The resource planning hub 310 electronically communicates with the driver profile module 314.

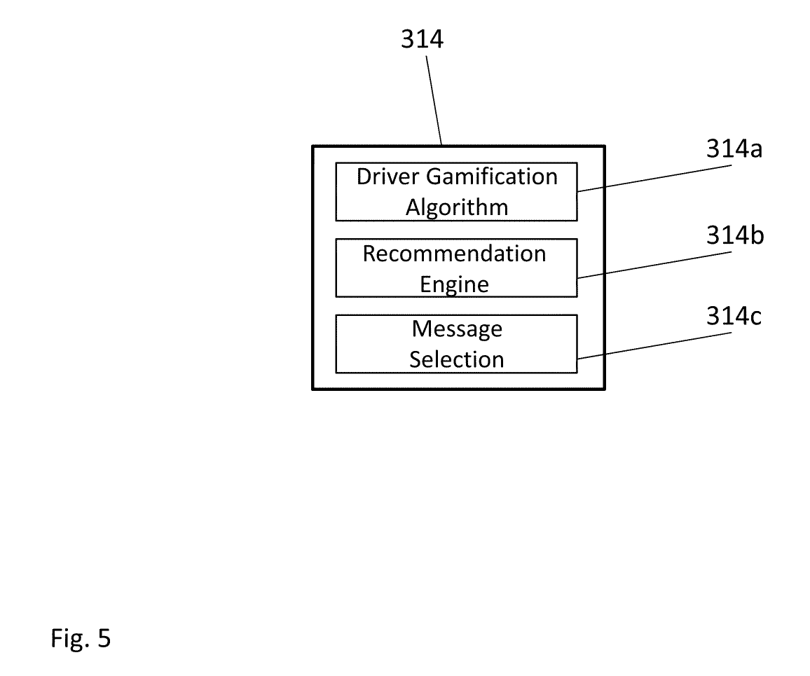

As illustrated in FIG. 5, the driver profile module 314 includes a Gamification Algorithm 314a (see, for example, U.S. Provisional Appln. No. 61/749,600, filed Jan. 7, 2013, and U.S. application Ser. No. 13/837,955, filed Mar. 15, 2013, which as noted above are incorporated herein by reference in full), a Recommendation Engine 314b, and a Message Selection 314c. As discussed in more detail below, the Gamification Algorithm 314a, Recommendation Engine 314a, and Message Selection 314c are used to customize messages transmitted to the customer 220 based on at least one of carrier identity and a customer's historical profile (e.g., a driver customization profile).

The driver profile module 314 electronically communicates with the communication hub 316. In a step 528, the driver profile module 314 transmits message data based on a driver customization profile to the communication hub 316 for sending a message to a customer 220. The data transmitted to the communication hub 316 is based on the communication request data and, optionally, is customized based on the Gamification Algorithm 314a, Recommendation Engine 314b, and Message Selection 314c. The resource planning hub 310 transmits transaction processing results back to the transaction hub 130 in a step 530. The transaction processing results are transmitted by the transaction hub 130 back to the carrier via, for example, secure FTP 302 in a step 532 to inform the carrier the device 104 has shipped to the customer 220 (see FIG. 1).

After receiving the message data from the driver profile module 314 in the Step 528, the communication hub 316 transmits communication data (e.g., a message) to the customer 220 in a step 534 to inform the customer 220 (see FIG. 1) that the device 104 has shipped. It is contemplated that the communication data transmitted to the customer 220 is customized based on the carrier and the Gamification Algorithm 314a, Recommendation Engine 314b, and Message Selection 314c. For example, carrier customizations may be programmed into the communication hub 316 to reduce the number of communications between the communication hub 316 and the carrier center 124. Such customizations may include, in a step 536, follow-up communications to the customer 220 on a previously defined frequency and/or periodic basis that may be based on carrier customization.

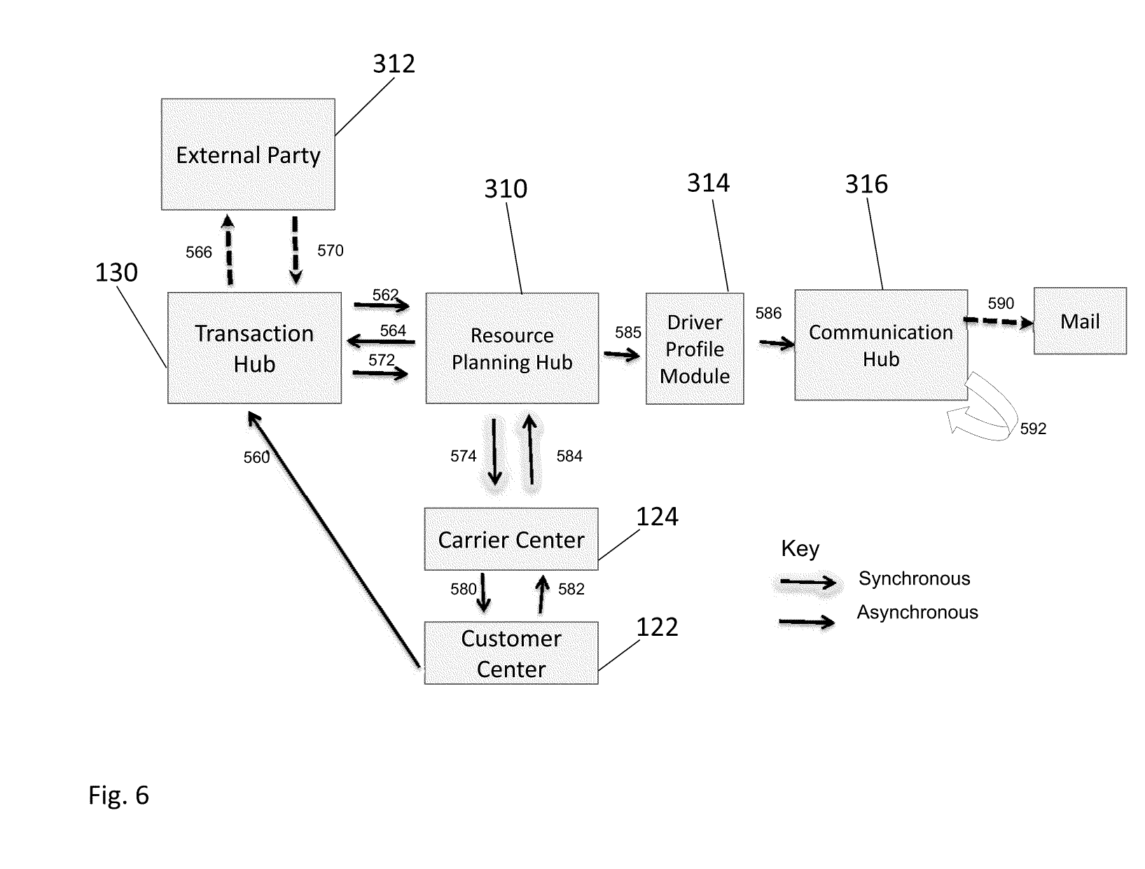

With reference FIG. 6, a block diagram showing an exemplary process for changing customer information is illustrated in accordance with one embodiment of an apparatus illustrating principles of the present invention. As discussed above, with reference to FIG. 4, solid lines represent asynchronous communications between different components with the integration system 300 and highlighted solid lines represent synchronous communications between the different components within the integration system 300.

FIG. 6 is also an exemplary methodology of the process for changing customer information. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

A change is initiated in the customer center 122. If a customer 220 moves to a different state, which is governed by different laws, an update to the device 104 may be necessary. For example, laws in the original state may allow comparing the vehicle speed with the allowable speed limit, while the new state does not. Therefore, the device 104 (see FIG. 1) may be updated no longer track comparing the vehicle speed with the allowable speed limit. A similar process is followed if the customer's insurance program or policy changes, requiring different data for rating and thus requiring a change to the device configuration.

In a Step 560, the customer center 122 optionally transmits initial data requesting the change to the transaction hub 130. Then, in a Step 562, the transaction hub 130 transmits the initial data requesting a change to the resource planning hub 310. If the transaction code is CHANGE, the resource planning hub 310 transmits an order request to the transaction hub 130 in a Step 564. The transaction hub 130 transmits the order request to the external party 312, in a Step 566, for completing an over-the-air (OTA) (e.g., wireless) update to the device 104 (see FIG. 1).

A confirmation is transmitted from the external party 312 to the transaction hub 130 in a Step 570. The transaction hub 130 transmits data to the resource planning hub 310, in a Step 572, indicating the confirmation has been received from the external party 312. The resource planning hub 310 transmits data to the carrier center 124, in a Step 574, indicating the update has been confirmed. The updated device data is transmitted to the customer center 122 in a Step 580. Transaction results are transmitted to the carrier center 124 and the resource planning hub 310 in respective Steps 582 and 584.

The resource planning hub 310 transmits data to the driver profile module 314 in a Step 585. The driver profile module 314 may use the Gamification Algorithm 314a, Recommendation Engine 314b, and Message Selection 314c to customize messages to the customer 220. For example, if the customer's history indicates the customer 220 has a tendency to drive significantly faster than the posted speed limit, the Gamification Algorithm 314a may cause a message to be transmitted to the customer 220 for providing incentives for achieving at least one of a goal (e.g., driving within the posted speed limit), a game, and a challenge. Similarly, the Recommendation Engine 314b may cause a message to be sent to the customer 220 recommending at least one of a goal (e.g., to drive within the posted speed limits), a game, and a challenge. The Message Selection 314c may cause a previously stored (e.g., “canned”) message, one of several message templates the carrier typically provides to send to the customer 220. The driver profile module 314 transmits the message data to the communication hub 316 in a Step 586 for notifying the customer 220 (see FIG. 2) of the change and providing any of the customized messages. The communication hub 316 transmits a notification of the change and other customized messages to the customer 220 (see FIG. 2) in a Step 590. Periodic customized follow-up messages, as discussed above with reference to FIG. 4, may be transmitted to the customer 220 (see FIG. 2) in a Step 592.

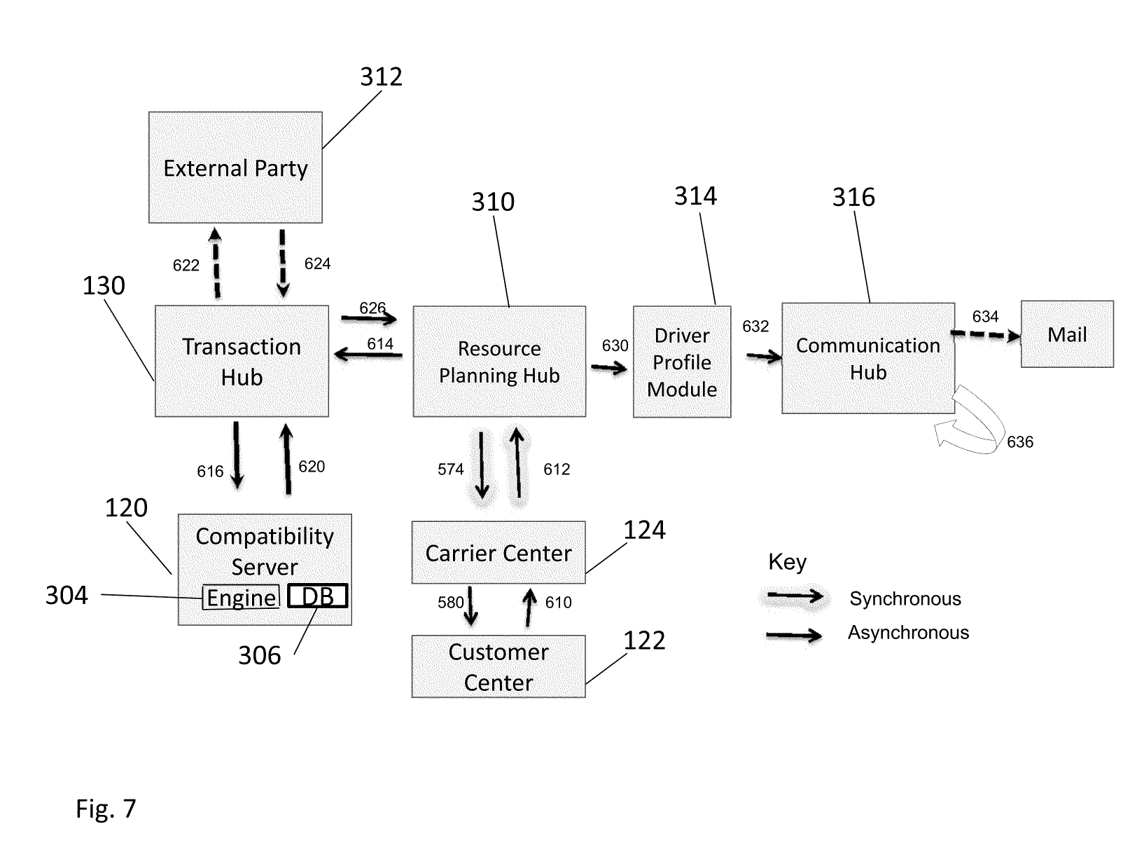

In another example with reference to FIG. 7, a transaction code of ADD is used if, for example, a customer 220 purchases a new car and needs a new device 104. The customer request for a new device 104 is initiated in the carrier center 124 in a Step 612. The carrier center 124 identifies the carrier associated with the customer 220 and transmits the customer request along with the carrier identity to the resource planning hub 310 in a Step 612. The resource planning hub 310 transmits the request to the transaction hub 130 in a Step 614. The transaction hub 130 transmits data identifying vehicle identification information to the compatibility server 120 in a Step 616. The compatibility server 120 identifies a new and compatible device 104, and transmits data identifying the device to the transaction hub 130 in a Step 620. The transaction hub 130 transmits data identifying the device to the external party 312 in a Step 622 and receives confirmation of shipment in a Step 624. The device identity and confirmation of shipment are transmitted from the transaction hub 130 to the resource planning hub 310 in a Step 626. The resource planning hub 310 transmits communication request data to the driver profile module 314 in a Step 630, and the driver profile module 314 transmits message data to the communication hub 316 in a Step 632. The communication hub 316 transmits a message to the customer in a Step 634 (with follow-up messages optionally sent in a Step 636).

As previously discussed, the driver profile module 314 may use the Gamification Algorithm 314a, Recommendation Engine 314b, and Message Selection 314c to customize messages to the customer 220. For example, if the customer's history indicates the customer 220 has a tendency to drive significantly faster than the posted speed limit and is now purchasing a higher performance vehicle, the Gamification Algorithm 314a may present opportunities to the customer 220 to provide incentives for driving within the posted speed limit. Similarly, the Recommendation Engine 314b may provide messages to the customer 220 recommending to drive within the posted speed limits. The Message Selection 314c may select previously stored (e.g., “canned”) messages the carrier typically provides to the customer 220.

Although only the NEW, INF, and ADD transaction codes have been discussed in detail, it is to be understood that any number of different transaction codes may be used. For example, a transaction code of TRANSFER DEVICE, RETURN, REPLACE DEVICE, UPDATE CONTACT, UPDATE ACCOUNT, DEACTIVATE ACCOUNT, DEACTIVATE VEHICLE, REQUEST STATUS., and/or DEVICE PROBLEM may also be valid transaction codes. For example, if a malfunction is detected with the device 104, a determination is made to either replace the device or abandon the device. If the device is to be replaced, a transaction is initiated with the transaction code REPLACE DEVICE, which would notify the carrier via, for example, data transmitted from the transaction hub 130, and customer via, for example, a message transmitted from the communication hub 316, that the device is to be returned for a replacement. The replacement device could be shipped to the customer either before or after receiving the original device. Alternatively, if the device is to be abandoned, a transaction is initiated with the transaction code ABANDON DEVICE, which would notify the carrier and customer that the device is to simply be abandoned. It is to be understood that although the specific transaction codes have been itemized here, other transaction codes for other purposes are also contemplated. Similarly, transaction codes identified by different names, but intended for similar purposes, are also contemplated.

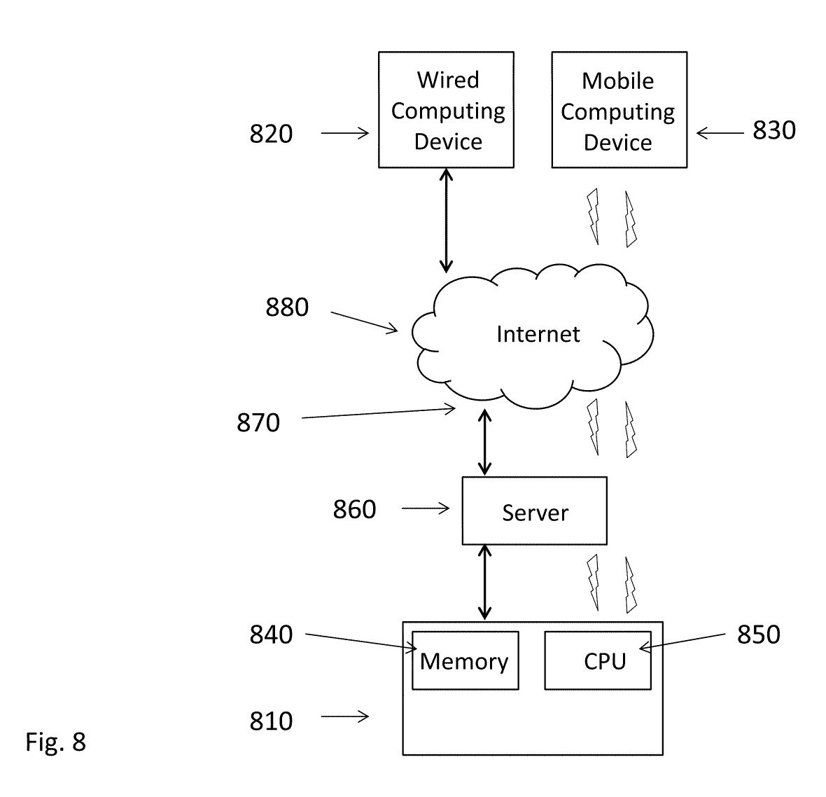

FIG. 8 includes an exemplary depiction of exemplary communication protocols and exemplary devices containing the platform 200 and/or processes and their associated applications. The devices can include the means for executing logic associated with the platform 200 and/or processes, and their associated applications. The platform 200 may be executed on a variety of computing devices 810, including, e.g., wired devices 820 (e.g., desktop computers) and mobile devices 830 (e.g., smartphones and tablets), kiosks, or any other device capable of hosting or presenting the platform 200 to a user with a display and input mechanism. The platform 200 may be stored in the memory 840 of a device and processed by a central processing unit (CPU) 850. The platform 200 may be stored and accessed via the same device, stored remotely in a first device and accessed via a different second device, or any other combination thereof. The platform 200 and/or its associated logic may be stored in local or remote memory (e.g., of a server 860), and accessible directly or via a network 870 (e.g., over the internet 880). The platform 200 may also be a web-based application accessible via the internet 880. A database associated with the platform 200 may be located in the same or different memory location than the platform 200. Similarly, a database associated with the platform 200 may be accessed the same way or differently than the platform 200.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. An integration system, comprising:
a transaction hub receiving initial data, the initial data including a transaction code;
a compatibility server, electronically communicating with the transaction hub, the transaction hub transmitting vehicle identification data to the compatibility server based on the transaction code, the compatibility server identifying a vehicle based on the vehicle identification data, identifying any potential devices compatible with the vehicle, identifying one of the potential devices based, at least in part, on prior feedback of at least one compatibility parameter, and transmitting device identifying data to the transaction hub.

2. The integration system as set forth in claim 1, wherein:
the compatibility parameter includes at least one of ergonomic design, operating cost, and likelihood of compatibility of the device.

3. The integration system as set forth in claim 1, further including:
a communication hub receiving communication request data based on transaction data transmitted from the transaction hub, the communication hub transmitting communication data based on the communication request data.

4. The integration system as set forth in claim 3, further including:
a driver profile module receiving profile request data based on the transaction data transmitted from the transaction hub, the driver profile module transmitting the communication request data to the communication hub.

5. The integration system as set forth in claim 4, wherein:
the communication hub transmits a message to a customer, the message being customized based on at least one of a carrier customization and a driver customization profile; and
additional messages customized based on the carrier being transmitted to the customer according to a frequency based on the carrier customization.

6. The integration system as set forth in claim 3, further including:
a resource planning hub electronically communicating with the transaction hub and the communication hub; and
a carrier module, electronically communicating with the resource planning hub, including carrier data;
wherein if the transaction code is NEW:
the transaction hub transmits the identified vehicle and the identified device to the resource planning hub;
the carrier module identifies a device configuration based on the identified vehicle, the identified device, and carrier data; and
the resource planning hub transmits data to the transaction hub identifying the device configuration.

7. The integration system as set forth in claim 1, further including:
a communication hub; and
a driver profile module receiving profile request data based on the transaction data transmitted from the transaction hub, the driver profile module transmitting communication request data to the communication hub;
wherein the driver profile module customizes the communication data transmitted to the customer based on at least one of carrier identity and a historical profile of the customer.

8. The integration system as set forth in claim 7, wherein the a driver profile module includes:
a gamification algorithm for causing the communication request data to include a message with an incentive to the customer for achieving at least one of a goal, a game, and a challenge.

9. The integration system as set forth in claim 7, wherein the a driver profile module includes:
a recommendation engine for causing the communication request data to include a message recommending at least one of a goal, a game, and a challenge.

10. The integration system as set forth in claim 1, further including if the transaction code is CHANGE:
a customer hub maintaining customer data including a device associated with the customer;
wherein the initial data requests a change to the device configuration via an over-the-air update; and
wherein the transaction hub receives the initial data from the customer hub.

11. The integration system as set forth in claim 10, further including:
a resource planning hub that electronically communicates with the transaction hub; and
a carrier hub that electronically communicates with the resource planning hub;
wherein if the transaction code is CHANGE:
the transaction hub transmits the initial data to the resource planning hub;
based on the initial data, the resource planning hub transmits an order request to the transaction hub; and
the transaction hub transmits the order request to an external party for completing an over-the-air update.

12. The integration system as set forth in claim 11, wherein if the transaction code is CHANGE:
after receiving confirmation that the device has been updated over-the-air, the resource planning hub transmits confirmation data to the carrier hub; and
the carrier hub transmits the data to the customer hub for updating the customer data to reflect the device was updated over-the-air.

13. The integration system as set forth in claim 1, further including if the transaction code is ADD:
a carrier center maintaining customer data including a carrier associated with the customer;
wherein the compatibility server identifies a new device compatible with new vehicle identification information and transmits data identifying the new device to the transaction hub; and
wherein the transaction hub transmits data identifying the new device to an external party.

14. The integration system as set forth in claim 1, further including:
a communication hub transmitting a message to a customer;
wherein if the transaction code is REPLACE:
the transaction hub transmits data notifying a carrier the device is to be returned; and
the communication hub transmits a message to a customer that the device is to be returned.

15. A method of coordinating transactions in a usage-based insurance platform, comprising:
receiving initial data by a transaction hub, the initial data including a transaction code;
transmitting vehicle identification data to a compatibility server based on the transaction code;
identifying a vehicle based on the vehicle identification data;
identifying any potential devices compatible with the vehicle;
identifying one of the potential devices based, at least in part, on prior feedback of at least one compatibility parameter; and
transmitting device identifying data from the compatibility server to the transaction hub.

16. The method of coordinating transactions as set forth in claim 15, further including:
transmitting the identified vehicle and the identified device from the transaction hub to a resource planning hub;
identifying a device configuration based on the identified vehicle, the identified device, and carrier data; and
transmitting data, which identifies the device configuration, from the resource planning hub to the transaction hub.

17. The method of coordinating transactions as set forth in claim 16, further including:
transmitting the carrier data from a carrier module to the resource planning hub, the carrier data identifying configuration parameters associated with a carrier.

18. The method of coordinating transactions as set forth in claim 16, further including:
transmitting communication data from a communication hub to a customer.

19. The method of coordinating transactions as set forth in claim 18, further including:
customizing the communication data based on the carrier.

20. The method of coordinating transactions as set forth in claim 18, further including:
causing the communication data to include a message with an incentive to the customer for achieving at least one of a goal, a game, and a challenge.

21. The method of coordinating transactions as set forth in claim 18, further including:
causing the communication data to include a message recommending at least one of a goal, a game, and a challenge to the customer.

22. The method of coordinating transactions as set forth in claim 18, further including:
transmitting additional communication data from the communication hub to the customer based on a frequency determined by the carrier; and
customizing the additional communication data based on at least one of the carrier and the customer.

23. A method of determining a device compatibility in a usage-based insurance platform, the method comprising:
receiving vehicle identification data;
identifying a vehicle based on the vehicle identification data;
identifying any potential devices compatible with the vehicle; and
identifying one of the potential devices based, at least in part, on prior feedback of at least one compatibility parameter.

24. The method of determining a device compatibility in a usage-based insurance platform as set forth in claim 23, wherein the step of identifying one of the potential devices includes:
identifying the one potential device based on at least one of ergonomic design, operating cost, and likelihood of compatibility.

25. A system for an application coordinating transactions in a usage-based insurance platform, comprising:
a computer system, comprising a memory and a processor, wherein the memory comprises the application, and wherein the application comprises logic for:
receiving initial data by a transaction hub, the initial data including a transaction code;
transmitting vehicle identification data to a compatibility server based on the transaction code;
identifying a vehicle based on the vehicle identification data;
identifying any potential devices compatible with the vehicle;
identifying one of the potential devices based, at least in part, on prior feedback of at least one compatibility parameter; and
transmitting device identifying data from the compatibility server to the transaction hub.

26. A computer readable medium comprising an application for coordinating transactions in a usage-based insurance platform, wherein the application comprises logic for:
receiving initial data by a transaction hub, the initial data including a transaction code;
transmitting vehicle identification data to a compatibility server based on the transaction code;
identifying a vehicle based on the vehicle identification data;
identifying any potential devices compatible with the vehicle;
identifying one of the potential devices based, at least in part, on prior feedback of at least one compatibility parameter; and
transmitting device identifying data from the compatibility server to the transaction hub.

27. A system for an application coordinating transactions in a usage-based insurance platform, comprising:
means for receiving initial data by a transaction hub, the initial data including a transaction code;
means for transmitting vehicle identification data to a compatibility server based on the transaction code;
means for identifying a vehicle based on the vehicle identification data;
means for identifying any potential devices compatible with the vehicle;
means for identifying one of the potential devices based, at least in part, on prior feedback of at least one compatibility parameter; and
means for transmitting device identifying data from the compatibility server to the transaction hub.
